(19) United States
(12) Patent Application Publication
(10) Pub. No.: US 2010/0171914 A1
(43) Pub. Date: Jul. 8, 2010

(54) COMPOSITE RETARDATION PLATE, AND OPTICAL COMPENSATION POLARIZING PLATE AND LIQUID CRYSTAL DISPLAY DEVICE EQUIPPED WITH COMPOSITE RETARDATION PLATE

(76) Inventors: Katsuhiko Morishita, Osaka (JP); Takahiro Oka, Osaka (JP); Takehiko Sakai, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/676,388

(22) PCT Filed: Jul. 8, 2008
(86) PCT No.: PCT/JP2008/062360

§ 371 Date: Mar. 4, 2010

(30) Foreign Application Priority Data
Oct. 26, 2007 (JP) 2007-279667

(51) Int. Cl. G02F 1/13363

(52) U.S. Cl. 349/118; 349/119

(57) ABSTRACT

A composite retardation plate for use in a Twisted Nematic liquid crystal display device, at least includes: a first retardation film; and a second retardation film stacked on the first retardation film, the first retardation film being such that the first retardation film has a refractive index anisotropy which varies in thickness of the first retardation film so as to compensate for sequential variations in refractive index anisotropy of a liquid crystal layer included in the Twisted Nematic liquid crystal display device, the sequential variations being caused by a region which is approximately regarded as a region in which liquid crystal molecules hybridly orient during voltage application, and the second retardation film having a refractive index anisotropy for compensating for a residual refractive index anisotropy which remains after the compensation performed by the first retardation film. This provides a composite retardation plate which is capable of highly accurately compensating for a refractive index anisotropy which may cause a decrease in contrast of a TN liquid crystal display device due to a viewing angle.

### TECHNICAL FIELD

The present invention relates to an improvement in viewing angle characteristic of a Twisted Nematic liquid crystal display device.

### BACKGROUND ART

A Twisted Nematic (hereinafter abbreviated as TN) liquid crystal display device is adapted to a low voltage or a low power, and has an advantageous characteristic such that a display performance such as a contrast is excellent. Therefore, the TN liquid crystal display device is variously extensively used, for example, for a display screen of a mobile phone or a digital camera, and for a comparatively large-scale display screen of a laptop PC, a word processor, a monitor display device, or the like.

FIG. 12 illustrates how liquid crystal molecules 1001 employing a TN mode orient during no voltage application. Namely, the liquid crystal molecules 1001 employing the TN mode have a positive dielectric anisotropy. Therefore, the liquid crystal molecules 1001 are lying substantially in parallel to an upper substrate 1002 and a lower substrate 1003 during no voltage application. A direction in which the liquid crystal molecules 1001 orient is controlled so that (i) the orientation of the liquid crystal molecules 1001 is twisted by 90° from the upper substrate 1002 to the lower substrate 1003 and (ii) in the vicinity of the upper substrate 1002 and the lower substrate 1003, the liquid crystal molecules 1001 are tilted at a constant angle with respect to respective substrate surfaces of the upper substrate 1002 and the lower substrate 1003.

Note that the constant angle made with respect to the respective substrate surfaces is referred to as a pretilt angle, which is, for example, approximately 3° to 5°.

As described earlier, a direction in which the liquid crystal molecules 1001 orient at the surface of the upper substrate 1002 and a direction in which the liquid crystal molecules 1001 orient at the surface of the lower substrate 1003 are orthogonal to each other. Therefore, in a case where two polarizing plates whose respective absorption axes are also orthogonal to each other are provided on respective outsides of the upper substrate 1002 and the lower substrate 1003, during no voltage application, linearly polarized light which enters into a liquid crystal layer, for example, from the lower substrate 1003 side through the polarizing plate provided on the outside of the lower substrate 1003 travels helically in accordance with the twist orientation of the liquid crystal molecules 1001, and passes through the polarizing plate provided on the outside of the upper substrate 1002. Accordingly, the TN liquid crystal display device employing the above principle carries out a white display (such a display mode is referred to as a normally white mode).

On the other hand, while a voltage is being applied across the upper substrate 1002 and the lower substrate 1003, the liquid crystal molecules 1001 gradually rise as a higher voltage is applied. A direction in which the liquid crystal molecules 1001 rise follows a direction in which the liquid crystal molecules 1001 tilted at the pretilt angle. Further, when a voltage exceeding a threshold voltage is applied, an average direction in which the liquid crystal molecules 1001 orient finally becomes perpendicular to the upper substrate 1002 and the lower substrate 1003.

In this state, the linearly polarized light which enters into the liquid crystal layer for example from the lower substrate 1003 side through the polarizing plate provided on the outside of the lower substrate 1003 remains polarized and goes straight along the liquid crystal molecules 1001 which have risen. Therefore, the linearly polarized light cannot transmit the polarizing plate provided on the outside of the upper substrate 1002. Accordingly, this TN liquid crystal display device carries out a black display during voltage application.

However, even in case of the black display, in the vicinities of the respective surfaces of the upper substrate 1002 and the lower substrate 1003, the liquid crystal molecules 1001 are tilted at tilting angles sequentially varying from the liquid crystal molecules 1001 having a slope at the pretilt angle to the liquid crystal molecules 1001 which have perpendicularly risen (see FIG. 13). Namely, there exists a region H in which the liquid crystal molecules 1001 are oriented in hybrid orientation.

For this reason, the region H has a refractive index anisotropy which is unignorably great with respect to light which obliquely goes (see FIG. 13). As a result, the light leaks from the polarizing plate provided on the outside of the upper substrate 1002. Therefore, in a case where a display is obliquely seen, for example, from the upper substrate 1002 side, the display looks gray even if the display is black. Namely, a decrease in contrast caused in the case where the display is obliquely seen causes a deterioration in viewing angle characteristic.

In view of the circumstances, a method has been known as a measure for improving a viewing angle characteristic. In this method, a liquid crystal display device is provided with a layer which has an optical characteristic for compensating for a refractive index anisotropy of a region in which liquid crystal molecules hybridly orient.

Each of the following Patent Literatures 1 and 2 discloses a retardation plate which has such an optical characteristic. This retardation plate has an arrangement in which two kinds of films which are different in optical characteristic are adhered to each other. Such an arrangement gives the retardation plate a new retardation characteristic which cannot be obtained by one of the films alone. The Patent Literatures disclose that this allows a high-accuracy compensation for coloring caused particularly due to a viewing angle.

Furthermore, the following Non Patent Literature 1 discloses such a technique that: negative birefringent media are formed by hybridly orienting molecules of a discotic compound, and the negative birefringent media thus formed are provided in reflection symmetry on both sides of a TN liquid crystal cell, so that orientation components of on-state liquid crystal molecules are optically compensated for.

### Citation List

Patent Literature 1

Japanese Patent Application Publication, Tokukai, No. 2001-42128 A (Publication Date: Feb. 16, 2001)

Patent Literature 2

Japanese Patent Application Publication, Tokukai, No. 2001-42127 A (Publication Date: Feb. 16, 2001)

Non Patent Literature 1

Development of Wide View SA, a Film Product Widening the Viewing Angle of LCDs; Hiroyuki MORI, Yoji ITOH, Jun WATANABE, and Yukio SHINAGAWA; FUJI RESEARCH & DEVELOPMENT (No. 46-2001)

### SUMMARY OF INVENTION

However, the retardation plate disclosed in each of Patent Literatures 1 and 2 is merely a retardation plate such that two kinds of optical characteristics are combined by adhering two kinds of films to each other. Accordingly, it is impossible for the retardation plate to completely compensate for all the refractive index anisotropy which sequentially varies (see the region H illustrated in FIG. 13).

For this reason, the retardation plate disclosed in each of Patent Literatures 1 and 2 can only incompletely prevent a decrease in contrast of the liquid crystal display device.

Further, it is also impossible for the birefringent media disclosed in Non Patent Literature 1 to completely compensate for the refractive index anisotropy of the region H. Inventors of the present invention found that there exist a plurality of azimuth directions and viewing angle ranges where a degree of an improvement in viewing angle characteristic is extremely low (described later in detail). Namely, it remains to be solved as a technical problem what to do in order to: (i) further improve a viewing angle characteristic of a liquid crystal display device which has an arrangement as disclosed in Non Patent Literature 1 and (ii) realize a high contrast in a broad viewing angle range and even if a display surface of the liquid crystal display device is observed from any azimuth direction.

The present invention has been made in view of the problems, and an object thereof is to provide a liquid crystal display device which is excellent in display quality because the liquid crystal display device is provided with: (i) a composite retardation plate capable of highly accurately compensating for a refractive index anisotropy of a liquid crystal layer which refractive index anisotropy may cause a decrease in viewing angle characteristic of a TN liquid crystal display device and (ii) an optical compensation polarizing plate including the composite retardation plate.

In order to attain the object, a composite retardation plate in accordance with the present invention for use in a Twisted Nematic liquid crystal display device, at least includes: a first retardation film; and a second retardation film stacked on the first retardation film, the first retardation film being such that the first retardation film has a refractive index anisotropy which varies in thickness of the first retardation film so as to compensate for sequential variations in refractive index anisotropy of a liquid crystal layer included in the Twisted Nematic liquid crystal display device, the sequential variations being caused by a region which is approximately regarded as a region in which liquid crystal molecules hybridly orient during voltage application, and the second retardation film having a refractive index anisotropy for compensating for a residual refractive index anisotropy which remains after the compensation performed by the first retardation film.

A liquid crystal material having a positive dielectric anisotropy is used for the Twisted Nematic (hereinafter referred to as TN) liquid crystal display device. Therefore, during no voltage application, an average direction in which liquid crystal molecules orient is substantially parallel to the respective substrate surfaces of upper and lower substrates which sandwich the liquid crystal layer. On the other hand, when a voltage which is so high as to exceed a threshold is applied, the average direction in which the liquid crystal molecules orient is perpendicular to the respective substrate surfaces of upper and lower substrates which sandwich the liquid crystal layer.

However, in the vicinities of the respective substrate surfaces, each of the liquid crystal molecules has a pretilt angle and orients under control so as to orient in respective rubbing directions of the upper and lower substrates. Therefore, while the voltage is being applied to the liquid crystal layer, there occur sequential variations in rise of the liquid crystal molecules between the pretilt angle and 90° with respect to the respective substrate surfaces. Such a state of orientation in which state there occur sequential variations in rise of the liquid crystal molecules is approximately regarded as a hybrid orientation. Accordingly, a region which is in the vicinity of the substrate surface and in which region an approximate hybrid orientation occurs is referred to as a hybrid orientation region.

The liquid crystal molecules which hybridly orient cause light going obliquely particularly to the substrate surface to be birefringent. Further, an angle at which light enters into the substrate surface and which causes the light to be more birefringent sequentially varies as a slope of the liquid crystal molecules which hybridly orient sequentially varies from the substrate surface. Namely, the hybrid orientation region more or less causes the light going obliquely to the substrate surface to be birefringent, irrespective of an angle at which the light enters into the substrate surface.

In view of the circumstances, first, the first retardation film compensates for a birefringence which sequentially varies so that this angle at which light enters into the substrate surface, that is, a birefringence which sequentially changes in accordance with a viewing angle is corrected, that is, compensated for, so as to approach 0 (zero) in any viewing angle, irrespective of a viewing angle. The first retardation film is such that the first retardation film has the refractive index anisotropy which varies in the thickness so as to carry out such a compensation to some extent.

However, there is a birefringence which remains after the compensation performed by the first retardation film. As a result, there exist a plurality of azimuth directions and viewing angle ranges where a degree of an improvement in viewing angle characteristic is extremely low. This is because: (i) a plurality of liquid crystal molecules gradually rise with respect to the substrate surface so as to have a twisted orientation and (ii) it is extremely difficult to cause the first retardation film to have a compensation characteristic such that the first retardation has the refractive index anisotropy which varies in the thickness in response to this twisted orientation.

The inventors of the present invention noted the importance of this point and concluded that it is possible to remarkably improve a display quality by newly providing means for compensating for a residual birefringence which remains after the compensation performed by the first retardation film. The second retardation film as such means is provided in the composite retardation plate of the present invention. Namely, the second retardation film which compensates for the residual birefringence which is included in the sequential variations in refractive index anisotropy in the liquid crystal layer and remains after the compensation performed by the first retardation film is stacked on the first retardation film.

Because of this, the light emitted from the composite retardation plate is one that is corrected so that the birefringence further approaches 0 (zero) than the conventional art, irrespective of a viewing angle. Therefore, in the TN liquid crystal display device with this composite retardation plate, the composite retardation plate enters not an elliptically polarized light but a substantially linearly polarized light into a polarizing plate of the composite retardation plate from which polarizing plate the light outgoes. This achieves an increase in contrast.

In detail, for example, in a normally white liquid crystal display device which carries out a black display during voltage application, the optical compensation of the composite retardation plate of the present invention works such that the linearly polarized light which enters into the polarizing plate has a polarization plane orthogonal to a transmission axis of the polarizing plate during the voltage application. This causes the polarizing plate to absorb the light, so that the black display is favorably carried out. This achieves an increase in contrast.

On the other hand, for example, in a normally black liquid crystal display device which carries out a white display during voltage application, the optical compensation of the composite retardation plate of the present invention works such that the linearly polarized light which enters into the polarizing plate has a polarization plane parallel to the transmission axis of the polarizing plate during the voltage application. This causes the light to transmit the polarizing plate, so that the white display is favorably carried out. This achieves an increase in contrast.

In order to attain the object, a composite retardation plate of the present invention for use in a TN liquid crystal display device, at least includes: a first retardation film; and a second retardation film stacked on the first retardation film, and the composite retardation plate is arranged such that: the first retardation film has a refractive index anisotropy expressed by nx=ny>nz in the vicinity of a first surface and refractive index ellipsoids satisfying a relation of nx=ny>nz have slopes which vary in the thickness so that minor axes of the refractive index ellipsoids and the z-axis gradually form greater angles from the first surface toward a second surface; and the second retardation film has a refractive index anisotropy expressed by nx>nz>ny, where a z-axis is a thickness direction of the composite retardation plate and an x-axis and a y-axis are orthogonal to each other in a plane which is perpendicular to the thickness direction, and refractive indices of respective directions along the x-axis, the y-axis, and the z-axis are indicated as nx, ny, and nz, respectively, and the first surface and second surface of the first retardation film are two surfaces of the first retardation film which face each other in the thickness direction and (i) the first surface faces the second retardation film and (ii) the second surface is a reverse side of the first surface.

According to the arrangement, in view of a y-z plane determined by the y-axis and the z-axis and an x-y plane determined by the x-axis and the y-axis, the x-y plane is parallel to the first surface of the first retardation film or a display surface of the TN liquid crystal display device because the z-axis is the thickness direction of the composite retardation plate.

A refractive index characteristic of TN liquid crystal molecules can be represented as a rugby ball-shaped refractive index ellipsoid. A major axis of the refractive index ellipsoid is a slow axis because of its highest refractive index. The liquid crystal molecule whose slow axis is parallel to the z-axis, that is, the liquid crystal molecule whose slow axis is perpendicular to the x-y plane is now to be considered as a risen liquid crystal molecule out of the liquid crystal molecules which approximately hybridly orient. A relation among nx, ny, and nz which are refractive indices of such a risen liquid crystal molecule is expressed by nz>nx=ny. Namely, the risen liquid crystal molecule has a positive uniaxial anisotropy.

Light obliquely entering into the first surface along the y-z plane is now to be considered. In this case, as for the refractive indices of the risen liquid crystal molecule which affect light obliquely entering toward the first surface along the y-z plane at an angle of α1 with respect to the z-axis, nx remains constant and ny increases to be ny1. Namely, the relation among nx, ny, and ny1 is expressed by nx=ny<ny1.

Furthermore, as for the refractive indices of the risen liquid crystal molecule which affect light obliquely entering toward the first surface at an angle of α2 which is greater than α1, nx remains constant and ny1 further increases to be ny2. Namely, the relation among nx, ny, ny1 and ny2 is expressed by nx=ny<ny1<ny2.

On the other hand, the first retardation film has a refractive index anisotropy expressed by nx=ny>nz, that is, a negative uniaxial anisotropy of the vicinity of the first surface.

In this case, as for the respective refractive indices of the vicinity of the first surface which affect the light obliquely entering from the first retardation film toward the first surface along the y-z plane at the angle of α1 with respect to the z-axis, nx remains constant and ny decreases to be ny3 (described later in detail with reference to drawings). Namely, the relation among nx, ny, and ny3 is expressed by nx=ny>ny3.

Moreover, as for the refractive indices of the vicinity of the first surface which affect the light obliquely entering toward the first surface at the angle of α2 which is greater than α1, nx remains constant and ny3 further decreases to be ny4. Namely, the relation among nx, ny, ny3 and ny4 is expressed by nx=ny>ny3>ny4. As a result, this comparative relation is in inverse relation to the comparative relation of nx=ny<ny1<ny2.

Accordingly, in a case where (i) the refractive index anisotropy of the vicinity of the first surface of the first retardation film and (ii) the refractive index anisotropy of the risen liquid crystal molecule are added together to work together on the light obliquely entering toward the first surface, the refractive index anisotropies (i) and (ii) offset each other.

Note, however, that the birefringence approaches 0 (zero) but incompletely becomes 0. The second retardation film corrects the birefringence thus remaining so that the birefringence further approaches 0.

The inventors of the present invention found that a high contrast can be realized even if the display surface is observed in a broad viewing angle and from any azimuth direction in a case where a relation of nx>nz>ny is determined as a refractive index characteristic of the second retardation film for compensating for the residual birefringence.

The second retardation film compensates for a refractive index anisotropy that remains uncompensated after (i) the tilted refractive index ellipsoids of the first retardation film and (ii) the liquid crystal molecule whose slow axis tilts toward the z-axis out of the liquid crystal molecules which approximately hybridly orient compensate for each other by an exactly identical optical function as described above.

Note that in a case where the minor axes of the refractive index ellipsoids of the first retardation film and the tilted slow axis of the liquid crystal molecule are parallel to each other, the respective refractive index anisotropies of the refractive index ellipsoids of the first retardation film and the tilted liquid crystal molecule best compensate for each other.

The composite retardation plate of the present invention is preferably arranged such that in the first retardation film, a sloping direction which has a direction in which the refractive index ellipsoids are sloped in such a manner that their minor axes are gradually tilted from the z-axis and which is parallel to the first surface is orthogonal to an extending direction of a slow axis of the second retardation film.

The composite retardation plate of the present invention is preferably arranged such that at least one of the first retardation film and the second retardation film includes a protecting film which has a refractive index anisotropy for further compensating for a residual refractive index anisotropy which remains after the compensation performed by the first retardation film and the second retardation film.

A protecting film is normally provided to at least one of the first retardation film and the second retardation film during respective production processes of the first retardation film and the second retardation film. It is also possible to cause such a protecting film to have no refractive index anisotropy. However, it is possible to further improve a display contrast by causing the protecting film to have the refractive index anisotropy for further compensating for the residual refractive index anisotropy which remains after the compensation performed by the first retardation film and the second retardation film.

Further, it is also possible to provide, as a unit, an unconventional optical compensation polarizing plate including: a composite retardation plate as mentioned above; and a polarizing plate for converting light which enters into the polarizing plate, into linearly polarized light.

A Twisted Nematic liquid crystal display device in accordance with the present invention includes: a first composite retardation plate as one of the composite retardation plate recited in claim 3; and a Twisted Nematic liquid crystal layer sandwiched between a first substrate and a second substrate, the first substrate being stacked on a first retardation film included in the first composite retardation plate and the second substrate facing the first substrate, in case of referring to (i) the sloping direction of the first retardation film included in the first composite retardation plate and (ii) a rubbing direction of the first substrate as a first sloping direction and a first rubbing direction, respectively, the first sloping direction and the first rubbing direction being parallel to each other and identical in direction.

In a case where the composite retardation plate of the present invention is provided for the liquid crystal layer so that the first sloping direction and the first rubbing direction are parallel to each other and identical in direction as described above, a correspondence relation in which (i) respective minor axes of the refractive index ellipsoids which tilt in the first sloping direction and (ii) the tilted slow axis of the liquid crystal molecule are substantially parallel to each other is established with respect to various sloping angles in the first sloping direction. This causes the respective refractive index anisotropies of the first retardation film and the hybrid orientation region to best compensate for each other.

The Twisted Nematic liquid crystal display device further includes: a second composite retardation plate as another one of the composite retardation plate recited in claim 3, the second composite retardation plate including the first retardation film which is stacked on a surface of the second substrate which surface is opposite to a surface where the liquid crystal layer is provided, in case of referring to (i) the sloping direction of the first retardation film included in the second composite retardation plate and (ii) a rubbing direction of the second substrate as a second sloping direction and a second rubbing direction, respectively, the second sloping direction and the second rubbing direction being parallel to each other and identical in direction, the first rubbing direction and the second rubbing direction being orthogonal to each other.

The liquid crystal display device of the present invention is a Twisted Nematic liquid crystal display device. Therefore, the first rubbing direction and the second rubbing direction are orthogonal to each other in a conventional manner. The second composite retardation plate is provided in accordance with a relationship between these two rubbing directions.

This allows the second composite retardation plate to carry out the optical compensation as described earlier with respect to the hybrid orientation region which occurs in the liquid crystal layer in the vicinity of the second substrate during voltage application.

This allows the first composite retardation plate to favorably keep a linear polarization of linearly polarized light which obliquely enters through the polarizing plate provided on the first composite retardation plate side. Then, the linearly polarized light goes through the liquid crystal layer from above the first substrate toward the second substrate. The hybrid orientation region in the vicinity of the second substrate causes the linearly polarized light to be less linearly polarized. However, the second composite retardation plate recorrects the linear polarization of the less linearly polarized light. This allows well linearly polarized light to reach the polarizing plate provided on the second composite retardation plate side.

Consequently, the present invention makes it possible to provide a Twisted Nematic liquid crystal display device in which a viewing angle dependence of a contrast is greatly reduced and which is excellent in display quality.

Note that it is not essential to cause the first sloping direction and the first rubbing direction to be (i) parallel to each other, (ii) orthogonal to an extending direction of the slow axis of the second retardation film, and (iii) identical in direction. Instead of this, it may be arranged to cause (i) the first sloping direction and the extending direction of the slow axis of the second retardation film to be parallel to each other, (ii) the first sloping direction and the first rubbing direction to be orthogonal to each other, and (iii) the first rubbing direction and the extending direction of the slow axis to be orthogonal to each other.

Note also that in case of causing the first rubbing direction and the second rubbing direction to be orthogonal to each other and causing the first composite retardation plate and the second composite retardation plate such that the extending directions of the slow axes of their respective second retardation films are orthogonal to each other, it is not essential to cause the second sloping direction and the second rubbing direction to be parallel to each other and identical in direction. Instead of this, it may be arranged to cause the first sloping direction and the second rubbing direction to be parallel to each other and identical in direction and to cause the second sloping direction and the first rubbing direction to be parallel to each other and identical in direction.

As described earlier, the Twisted Nematic liquid crystal display device is more preferably arranged such that in each of the first composite retardation plate and the second composite retardation plate, at least one of the first retardation film and the second retardation film includes a protecting film which has a refractive index anisotropy for compensating for a residual refractive index anisotropy which remains after the compensation performed by the first retardation film and the second retardation film.

Note that a feature recited in one claim is combinable not only with a feature recited in the other claims from which the claim is dependent, but also with any other claims from which the claim is not dependent, provided that the object of the present invention can be attained.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 is a diagram schematically illustrating optical states of respective layers of a liquid crystal display device including a composite retardation plate in accordance with the present invention.

FIG. 2

FIG. 2 is an explanatory diagram illustrating an optical compensation function of the composite retardation plate in accordance with the present invention.

FIG. 3

FIG. 3 is an explanatory diagram illustrating an optical compensation relation among the respective layers of the liquid crystal display device.

FIG. 4

FIG. 4 is an explanatory diagram illustrating a comparison of how layers are arranged in a liquid crystal display device, between an example of the present invention and a comparative example.

FIG. 5

FIG. 5 is a graph illustrating transmittance characteristics obtained respectively at specific azimuths in a case where respective liquid crystal display devices of the example of the present invention and the comparative example are caused to carry out a white display.

FIG. 6

FIG. 6 is a graph illustrating transmittance characteristics obtained in all azimuth directions in a case where the respective liquid crystal display devices of the example of the present invention and the comparative example are caused to carry out the white display.

FIG. 7

FIG. 7 is a graph illustrating transmittance characteristics obtained respectively at specific azimuths in a case where the respective liquid crystal display devices of the example of the present invention and the comparative example are caused to carry out a black display.

FIG. 8

FIG. 8 is a graph illustrating transmittance characteristics obtained in all azimuth directions in a case where the respective liquid crystal display devices of the example of the present invention and the comparative example are caused to carry out the black display.

FIG. 9

(a) through (d) of FIG. 9 are graphs illustrating contrasts obtained respectively at specific azimuths as viewing angle characteristics of the respective liquid crystal display devices of the example of the present invention and the comparative example, and (e) through (h) of FIG. 9 are graphs which correspond to the graphs (a) through (d), respectively, of FIG. 9 and in which contrasts are reindicated by changing a scale of contrasts indicated in (a) through (d) of FIG. 9.

FIG. 10

FIG. 10 is a graph illustrating contrasts obtained in all azimuth directions as the viewing angle characteristics of the respective liquid crystal display devices of the example of the present invention and the comparative example.

FIG. 11

FIG. 11 illustrates, as a modified example corresponding to FIG. 4, how the layers are arranged in the liquid crystal display device.

FIG. 12

FIG. 12 schematically illustrates how TN liquid crystal molecules orient during no voltage application.

FIG. 13

FIG. 13 schematically illustrates how the TN liquid crystal molecules orient during voltage application.

### REFERENCE SIGNS LIST

1 Composite retardation plate

2 First retardation film

3 Second retardation film

4 TN cell (Liquid crystal layer)

5 TAC film (Protecting film)

41 Liquid crystal molecule

42 Liquid crystal molecule

43 Liquid crystal molecule

A1 Sloping direction (First sloping direction)

A2 Sloping direction (Second sloping direction)

B1 Slow axis of the second retardation film

B2 Slow axis of the second retardation film

D1 Rubbing direction (First rubbing direction)

D2 Rubbing direction (Second rubbing direction)

H Region (Region which is approximately regarded as a region in which a hybrid orientation occurs)

### DESCRIPTION OF EMBODIMENTS

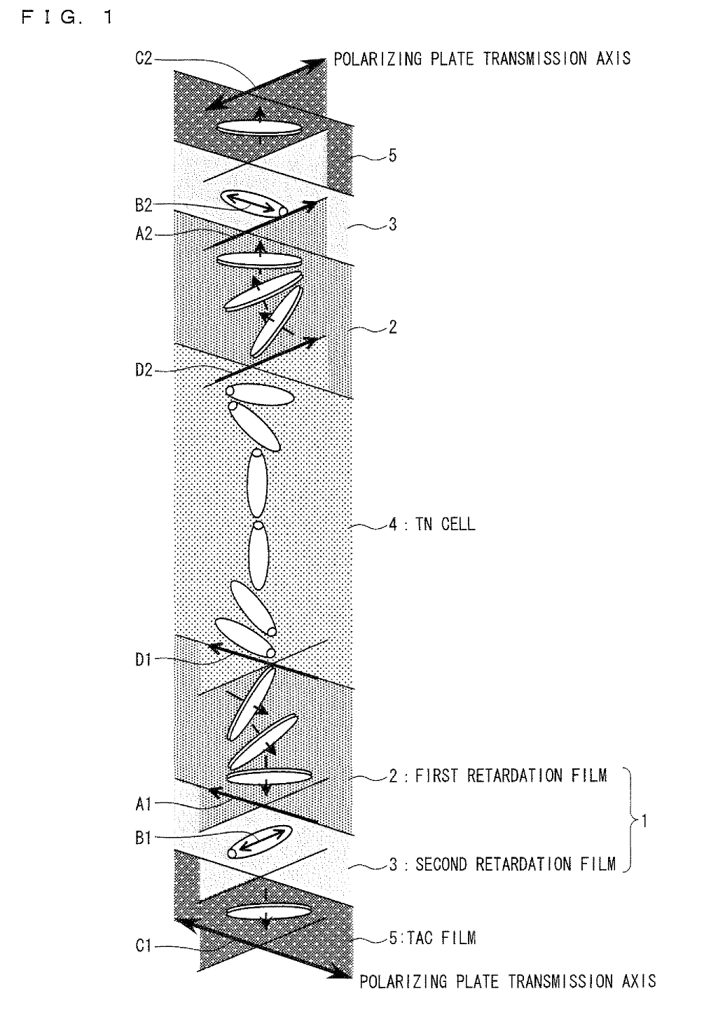

An embodiment of the present invention is described below with reference to FIGS. 1 through 10.

(Arrangement of Composite Retardation Plate)

A composite retardation plate 1 in accordance with the present invention basically includes a first retardation film 2 and a second retardation film 3 (see FIG. 1).

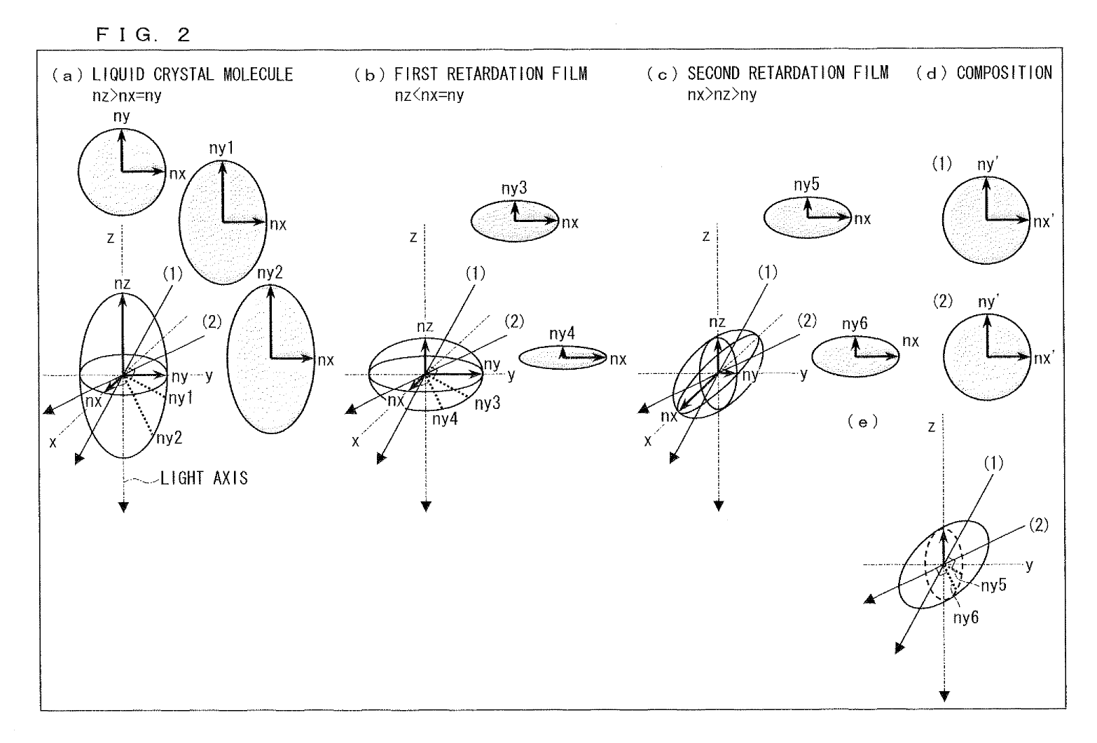

First, the first retardation film 2 is described below in detail. The first retardation film 2 has a refractive index anisotropy which varies in a thickness direction. The following schematically explains how the variation occurs. Assume that a z-axis is a thickness direction of the composite retardation plate 1 and an x-axis and a y-axis are orthogonal to each other in a surface perpendicular to the thickness direction. Further assume that refractive indices of respective directions along the x-axis, the y-axis, and the z-axis are denoted as nx, ny, and nz, respectively. In this case, the first retardation film 2 shows a negative uniaxial anisotropy expressed by nx=ny>nz in the vicinity of a lower surface (first surface) which is perpendicular to the thickness direction (see (b) of FIG. 2). The negative uniaxial anisotropy can be represented by refractive index ellipsoids as illustrated in (b) of FIG. 2. The minor axes of these refractive index ellipsoids and the z-axis gradually form greater angles, that is, as shown in FIG. 1, the minor axes of the refractive index ellipsoids closer to an upper surface (a second surface) and further from the lower surface are tilted at gradually greater angles with respect to the z-axis. The upper surface and the lower surface are perpendicular to the thickness direction.

Note that a sloping direction A1 illustrated in FIG. 1 is a direction along which the refractive index ellipsoids are sloped to tilt their minor axes at greater angles with respect to the z-axis so as to be away from the z-axis. Note also that the sloping direction A1 is parallel to the upper surface and the lower surface.

When the refractive index ellipsoid satisfying the relation of nx=ny>nz is sectioned by a y-z plane, a cross section (refer to (b) of FIG. 2) is obtained which has an ellipse shape whose major axis is parallel to the y-axis and whose minor axis is parallel to the z-axis. In a case where a direction in which this refractive index ellipsoid is looked at (hereinafter referred to as an eye-direction) is shifted from (1) to (2) in the y-z plane, a refractive index which affects, in the y-z plane in a direction perpendicular to the eye-direction, light going through the y-z plane in the eye-direction varies from ny, to ny3, and then to ny4 (see (b) of FIG. 2). Then, as the eye-direction becomes at a greater viewing angle with respect to the z-axis as from (1) to (2), the refractive index decreases as expressed by ny>ny3>ny4 and approaches nz.

Such a first retardation film 2 is produced by the steps: in which a transparent supporting member such as a TAC (Triacetylcellulose) film is coated with a discotic liquid crystal compound, the transparent supporting member thus coated is heated to a temperature where it has a discotic nematic phase, and the transparent supporting member thus heated is cross-linked by ultraviolet irradiation.

Note that the first retardation film is sometimes referred to as a GRP (Gradual Refraction Polarizer).

Next, the second retardation film 3 has a bi-axial anisotropy and a comparative relation among nx, ny, and nz is expressed by nx>ny>nz (see (c) of FIG. 2). Since nx is the largest of nx, ny, and nz, light goes through the second retardation film 3 slowest when a direction in which the light goes is parallel to the x-axis. Accordingly, the x-axis serves as a slow axis of the second retardation film 3.

FIG. 1 illustrates an optical characteristic of the second retardation film 3 by an ellipse, and a major axis of the ellipse schematically represents the slow axis. Note that in a case where the slow axis of the second retardation film 3 is indicated as a slow axis B1 (see FIG. 1), the second retardation film 3 is stacked on the first retardation film 2 so that the sloping direction A1 of the first retardation film 2 and the slow axis B1 are orthogonal to each other.

When the refractive index ellipsoid satisfying the relation of nx>nz>ny is sectioned by the y-z plane, a cross section (refer to (c) of FIG. 2) is obtained which has an ellipse shape whose major axis is parallel to the z-axis and whose minor axis is parallel to the y-axis. In a case where the eye-direction with respect to this refractive index ellipsoid is shifted from (1) to (2) in the y-z plane, a refractive index which affects, in the y-z plane in a direction perpendicular to the eye-direction, the light going through the y-z plane in the eye-direction varies from ny (see (c) of FIG. 2) to ny5 and then to ny6 (see (e) of FIG. 2). Then, as the eye-direction becomes at a greater viewing angle with respect to the z-axis as from (1) to (2), the refractive index increases as expressed by ny<ny5<ny6 and approaches nz.

(Arrangement of Liquid Crystal Display Device Including the Composite Retardation Plate)

Next, the following describes an arrangement of a Twisted Nematic (hereinafter referred to as TN) liquid crystal display device including the composite retardation plate of the present invention which has the foregoing arrangement.

The TN liquid crystal display device includes a TN cell 4 including an active matrix substrate and a counter substrate (which are not illustrated) provided so as to sandwich a TN liquid crystal layer (see FIG. 1). The TN liquid crystal layer is generally made of positive liquid crystals which orient along an electric flux line during the voltage application. However, the present invention is applicable not only to the positive liquid crystals but also to negative liquid crystals.

This TN cell 4 is vertically sandwiched between two composite retardation plates 1. Note that it is preferable that the two composite retardation plates 1 be vertically provided to sandwich the TN cell 4 so that their respective first retardation films 2 are adjacent to the TN cell 4.

Furthermore, polarizing plates in each of which a TAC film 5 is formed as a protecting film are provided so as to be adjacent to the respective composite retardation plates 1 which are vertically provided. The TAC film 5 may have a refractive index anisotropy of 0 (zero). Alternatively, the TAC film 5 may have the uniaxial anisotropy (see FIG. 1 and (b) of FIG. 2) so that each of the composite retardation plates 1 has a better optical compensation function.

Moreover, the TAC film 5 may be integrated with the polarizing plate. The TAC film 5 may also be integrated with the second retardation film 3 as the protecting layer for protecting the second retardation film 3. The TAC film 5 may be provided in any one or a plurality of the following positions: (i) between the polarizing plate and the second retardation film 3, (ii) between the first retardation film 2 and the second retardation film 3, and (iii) between the first retardation film 2 and the TN cell 4.

Further, it is possible to commercially produce a polarizing plate in which the polarizing plate, the TAC film 5 and the composite retardation plate 1 are integrated and which has the optical compensation function.

How to assemble the composite retardation plate 1, the TN cell 4, and the polarizing plate into lamination is determined as follows. First, a transmission axis C1 of the polarizing plate provided on the lower side is parallel to a rubbing direction D1 of a lower substrate surface of the TN cell 4. Next, the rubbing direction D1 is parallel to the sloping direction A1, and the rubbing direction D1 and the sloping direction A1 are identical in direction.

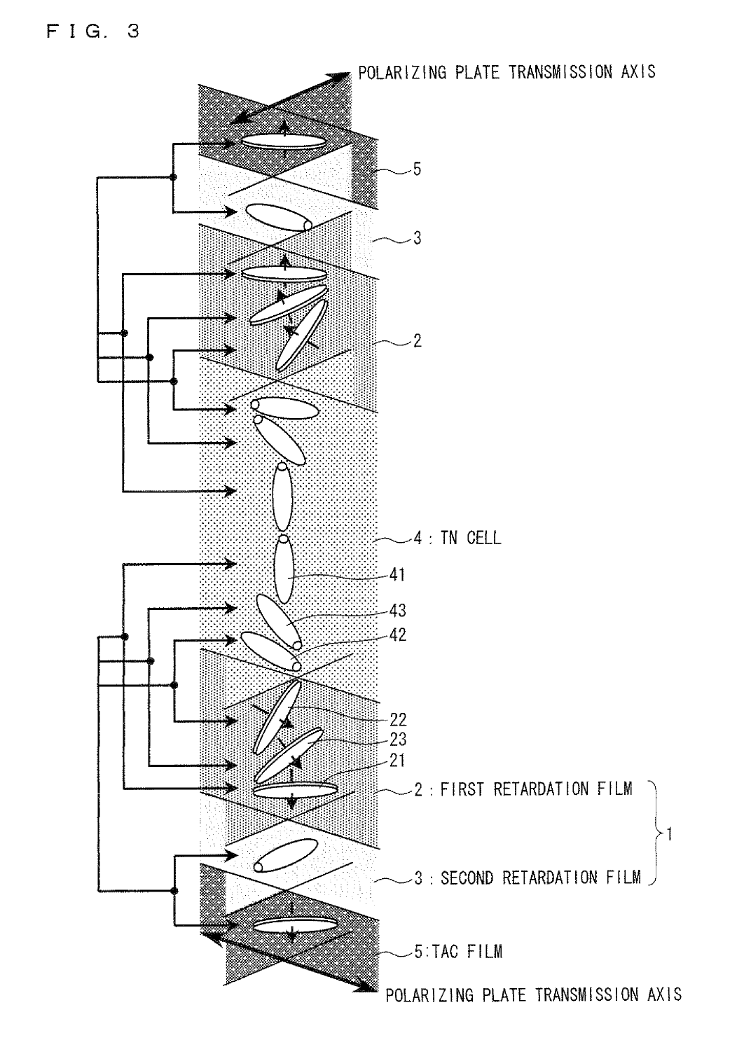

As shown in FIG. 3, this establishes an orthogonal relation between (i) a disk 21 representing a uniaxial anisotropy (nx=ny) of the vicinity of a lower surface of the first retardation film 2 and (ii) a slow axis of a liquid crystal molecule 41 which has a bend orientation in the TN cell 4 to be in an orthogonal relation. Similarly this establishes an orthogonal relation between (i) a disk 22 representing the uniaxial anisotropy of the vicinity of an upper surface of the first retardation film 2 which uniaxial anisotropy is expressed by nx=ny and represented by the refractive index ellipsoid and (ii) a slow axis of a liquid crystal molecule 42 which has a spray orientation in the TN cell 4. Furthermore, there is also an orthogonal relation between (i) a disk 23 provided between the disk 21 and the disk 22 and (ii) a slow axis of a liquid crystal molecule 43 which obliquely orients between the liquid crystal molecule 41 and the liquid crystal molecule 42.

On the other hand, an order in which the composite retardation plate 1 (a second composite retardation plate) and the corresponding polarizing plate are provided on the TN cell 4 is in mirror image fashion to that in which the composite retardation plate 1 (a first composite retardation plate) and the corresponding polarizing plate are provided under the TN cell 4. Note, however, that a rubbing direction D2 of an upper substrate surface of the TN cell 4 is orthogonal to the rubbing direction D1. Accordingly, a sloping direction A2 of the first retardation film 2 provided on the upper side is orthogonal to the sloping direction A1 of the first retardation film 2 provided on the lower side, and a slow axis B2 of the second retardation film 3 provided on the upper side is orthogonal to the slow axis B1 of the second retardation film 3 provided on the lower side.

Note also that a transmission axis C2 of the polarizing plate provided on the upper side is orthogonal to the transmission axis C1 of the polarizing plate provided on the lower side. This is because the TN liquid crystal display device generally employs a normally white mode in which: a white display is carried out during no voltage application, whereas a black display is carried out during voltage application. However, a normally black mode can also be employed in which the transmission axes C1 and C2 are parallel to each other.

(Optical Compensation Function of the Composite Retardation Plate)

In a case where the composite retardation plate 1 of the present invention which has the foregoing arrangement is provided in a Twisted Nematic liquid crystal display device, it is possible to dramatically improve a display contrast. As a reason for this, the following describes the optical compensation function carried out by the composite retardation plate 1 of the present invention.

The optical compensation function is summarized as follows. As to nx and ny each being a refractive index which affects light going through the TN cell 4 obliquely to the z-axis, the first retardation film 2 and the second retardation film 3 compensate for a refractive index anisotropy of the liquid crystal molecules so that the a relation of nx=ny is obtained through the combination of the liquid crystal molecules, the first retardation film 2, and the second retardation film 3 (see FIG. 2).

First, the liquid crystal molecule 41 (refer to FIG. 3) which has the bend orientation in the TN cell 4 has a positive uniaxial refractive index anisotropy (schematically illustrated in (a) of FIG. 2). In other words, nx, ny, and nz of the liquid crystal molecule 41 satisfy a relation of nz>nx=ny. Refractive indices which affect light going through the liquid crystal molecule 41 along the z-axis are nx and ny, which are isotropic due to the relation of nx=ny. Accordingly, in this case, the z-axis is a light axis of the liquid crystal molecule 41 and a slow axis for causing the light to decrease in speed.

Note that it is represented, by a circle, that the refractive indices which affect the light going through the liquid crystal molecule 41 along the z-axis are isotropic (see (a) of FIG. 2).

Next, a case where light (1) and light (2) each going through the liquid crystal molecule 41 along the y-z plane so as to tilt at a certain angle with respect to the z-axis is to be considered. For the light (1), a cross-section obtained when the refractive index ellipsoid illustrated in (a) of FIG. 2 is sectioned by a plane which (i) is perpendicular to a direction in which the light (1) goes and (ii) passes through an origin of x, y, and z is an ellipse whose minor axis is nx and whose major axis is ny1 (see (a) of FIG. 2).

Further, for the light (2) which tilts at a greater angle with respect to the z-axis than the light (1), the cross-section is an ellipse whose minor axis is nx and whose major axis is ny2. Note that as the light tilts at a greater angle with respect to the z-axis, the light is affected by a higher refractive index in the y-z plane. Namely, a relation of nx=ny<ny1<ny2<nz is established.

On the other hand, in a case where each of the light (1) and the light (2) goes through the first retardation film 2 along the y-z plane, first, the cross-section obtained for the light (1) is an ellipse whose major axis is nx and whose manor axis is ny3 (see (b) of FIG. 2).

Further, for the light (2), the cross-section is an ellipse whose major axis is nx and whose minor axis is ny4. Thus, in the case of the first retardation film 2, as the light tilts at a greater angle with respect to the z-axis, the light is affected by a lower refractive index in the y-z plane, contrary to the case of the liquid crystal molecule 41. Namely, a relation of nx=ny>ny3>ny4>nz is established.

This causes a refractive index anisotropy of the first retardation film 2 (nx=ny>ny3>ny4>nz) to compensate for that of the liquid crystal molecule 41 (nx=ny<ny1<ny2<nz) when each of the light (1) and the light (2) sequentially passes through the first retardation film 2 and the liquid crystal molecule 41. Then, each of the light (1) and the light (2) approaches a state of isotropy.

However, the refractive index anisotropy of the liquid crystal molecule 41 is insufficiently compensated for. In view of this, a refractive index anisotropy which remains even after the compensation performed with the combination of the first retardation film 2 and the liquid crystal molecule 41 is to be offset by a refractive index anisotropy of the second retardation film 3 (see a correspondence relation of the optical compensation which correspondence relation is illustrated in FIG. 3 by double-pointed arrows).

As described earlier, the refractive index anisotropy of the second retardation film 3 is expressed by nx>nz>ny. In a case where each of the light (1) and the light (2) goes through the first retardation film 2 along the y-z plane, the cross-section obtained for the light (1) is an ellipse whose major axis is nx and whose manor axis is ny5 (see (c) and (e) of FIG. 2).

Further, for the light (2), the cross-section is an ellipse whose major axis is nx and whose minor axis is ny6. Thus, in the case of the second retardation film 3, as the light tilts at a greater angle with respect to the z-axis, the light is affected by a higher refractive index in the y-z plane. Namely, a relation of ny<ny5<ny6<nz is established.

Finally, the refractive index anisotropy of the liquid crystal molecule 41 is compensated for by those of the first retardation film 2 and the second retardation film 3. As a result, in any case of the light (1) and the light (2), that is, irrespective of an angle of light entering into an x-y plane which is parallel to a display surface of the liquid crystal display device, a refractive index which affects the light entering into the x-y plane is expressed by nx′=ny′ (see (d) of FIG. 2).

Note that the above description focuses merely on a variation in ny on the assumption that respective nxs of the liquid crystal molecule 41, the first retardation film 2, and the second retardation 3 are identical in value. However, it is unnecessary that the respective nxs be identical in value, and it is possible to select the respective nxs so that nx′ obtained by a composition and ny′ obtained by the composition are finally identical or substantially identical.

The above description of the optical compensation function is applied to (i) the liquid crystal molecule 41 and (ii) the disk 21 representing the uniaxial anisotropy of the vicinity of the lower surface of the first retardation film 2 (see FIG. 3). However, this description is also applied to (i) the liquid crystal molecule 42 which is provided in the vicinity of the lower substrate of the TN cell 4 and (ii) the disk 22 which represents the uniaxial anisotropy of the vicinity of the upper surface of the first retardation film 2. This is because the slow axis of the liquid crystal molecule 42 and the disk 22 are in the orthogonal relation as described earlier. Similarly, the above description is also applied to (i) the liquid crystal molecule 43 which is provided between the liquid crystal molecule 41 and the liquid crystal molecule 42 in a thickness direction of the TN cell 4 and (ii) the disk 23 which represents a uniaxial anisotropy of a center of a thickness of the first retardation film 2.

(The Optical Compensation Function of the TAC Film)

It is possible to cause the TAC film 5 provided outside the composite retardation plate 1 to have no optical anisotropy. However, it is also possible to cause the composite retardation plate 1 to have a better optical compensation function by causing the TAC film 5 to have a negative uniaxial anisotropy and providing the TAC film 5 so that a light axis is perpendicular to the display surface. Alternatively, a refractive index anisotropy of liquid crystals can be substantially completely offset by a combination of the composite retardation plate 1 and the TAC film 5.

### EXAMPLES

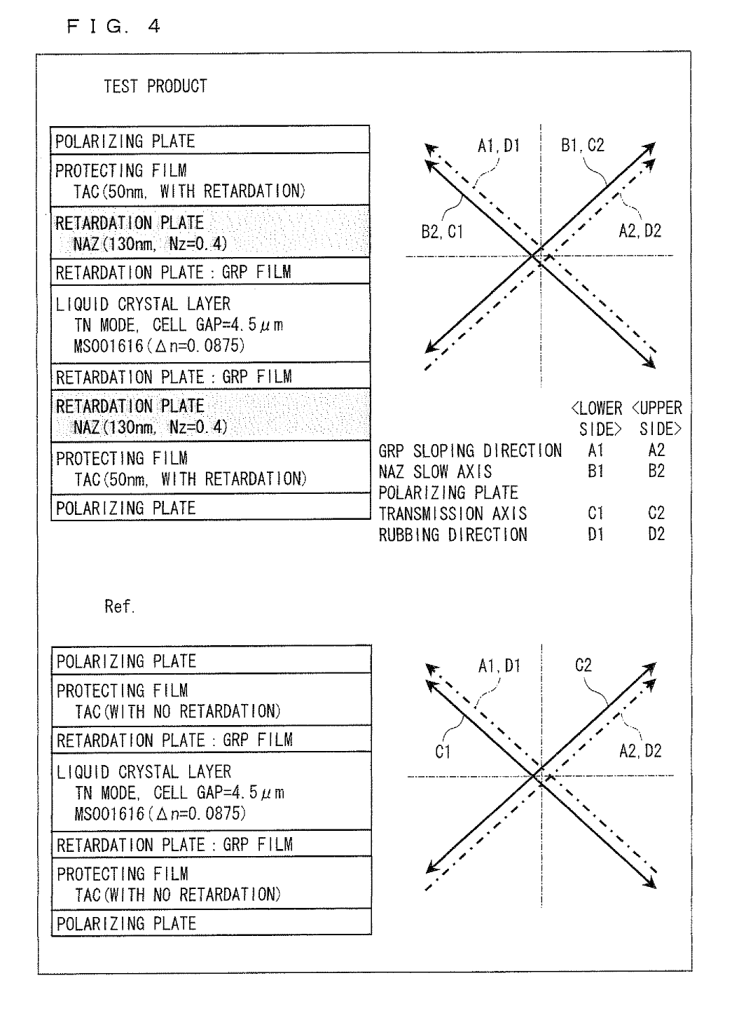

An example of the present invention is described below with reference to FIGS. 4 through 10.

(Arrangement Example of the Liquid Crystal Display Device)

A liquid crystal display device of the present example is identical in basic arrangement with the arrangement example illustrated in FIG. 1. In an “test product” illustrated in FIG. 4, a “retardation plate: GRP film”, a “retardation plate”, a “liquid crystal layer”, and a “protecting film TAC” correspond to: the first retardation film 2, the second retardation film 3, the TN cell 4, and the TAC film 5, respectively. A pair of polarizing plates which are in a crossed Nicols relationship is provided on an upper surface and a lower surface, respectively, of this liquid crystal display device, similarly to the pair of polarizing plates illustrated in FIG. 1.

Furthermore, on a lower side of this liquid crystal display device, a sloping direction of the “retardation plate: GRP film”, a slow axis of the “retardation plate”, a transmission axis of the polarizing plate, and a rubbing direction of a lower substrate of the “liquid crystal layer” correspond to: the sloping direction A1, the slow axis B1, the transmission axis C1, and the rubbing direction D1, respectively, of FIG. 1.

On the other hand, on an upper side of this liquid crystal display device, the sloping direction of the “retardation plate: GRP film”, the slow axis of the “retardation plate”, the transmission axis of the polarizing plate, and the rubbing direction of the lower substrate of the “liquid crystal layer” correspond to: the sloping direction A2, the slow axis B2, the transmission axis C2, and the rubbing direction D2, respectively, of FIG. 1.

A directional correlation between A1 through D1 and A2 through D2 is illustrated in FIG. 4 by arrows. This correlation is as described earlier with reference to FIG. 1.

For example, a wide view film (WV-SA) produced by FUJIFILM Corporation which is adaptable to an applied voltage of 6.5V was used for the “retardation plate: GRP film”. Note that there are GRP films adaptable to applied voltages of 4(V), 6.5(V), and the like because how liquid crystal molecules rise varies depending on an applied voltage.

For example, a NAZ (product name) film produced by Nitto Denko Corporation was used for the “polarizing plate”. The NAZ film has a thickness, for example, of 130 nm and an Nz coefficient, for example, of 0.4. Note that the Nz coefficient is one of the indices representing a comparative relation among nx, ny, and nz, and is determined by (nx−nz)/(nx−ny).

TN liquid crystals (model No. MS001616, produced by Merck Japan) having a birefringence Δn=0.0875 were used for the “liquid crystal layer”, and the “liquid crystal layer” was set to have a cell gap of 4.5 μm.

A TAC which has: (i) a light axis in a thickness direction, (ii) a negative uniaxial anisotropy, and (iii) a retardation of 50 nm was used for the “protecting film TAC”.

### COMPARATIVE EXAMPLE

In order to demonstrate that the liquid crystal display device of the example is excellent in characteristic, a comparative example was prepared.

A liquid crystal display device of the comparative example “Ref.” is arranged such that the “retardation plate” as the second retardation film 3 is reduced from the arrangement of the “test product” and a TAC having no birefringence is used as the “protecting film TAC”. There is no change in directional correlation between A1 through D1 and A2 through D2 as illustrated in FIG. 4 by arrows, except that B1 and B2 are deleted.

(Transmittance Characteristic: White Display)

First, respective transmittance characteristics of the “test product” and the “Ref.” were measured during a white display in which no voltage 0 (V) was applied. In a case where a reference light intensity detected by a measuring device was set to 1 (one) in a state where nothing was provided between a light source and the measuring device, the respective transmittance characteristics were determined as ratios to the reference light intensity.

Further, an azimuth in the display surface obtained when the display surface was horizontalized was shifted from 0° (a horizontal direction) and 90° (a vertical direction) to 45° and 135° (oblique azimuth directions). In all the azimuth directions, a polar angle which a direction in which the display surface is looked at from a light receiving section of the measuring device makes with respect to a normal direction of the display surface was shifted from −80° to +80°.

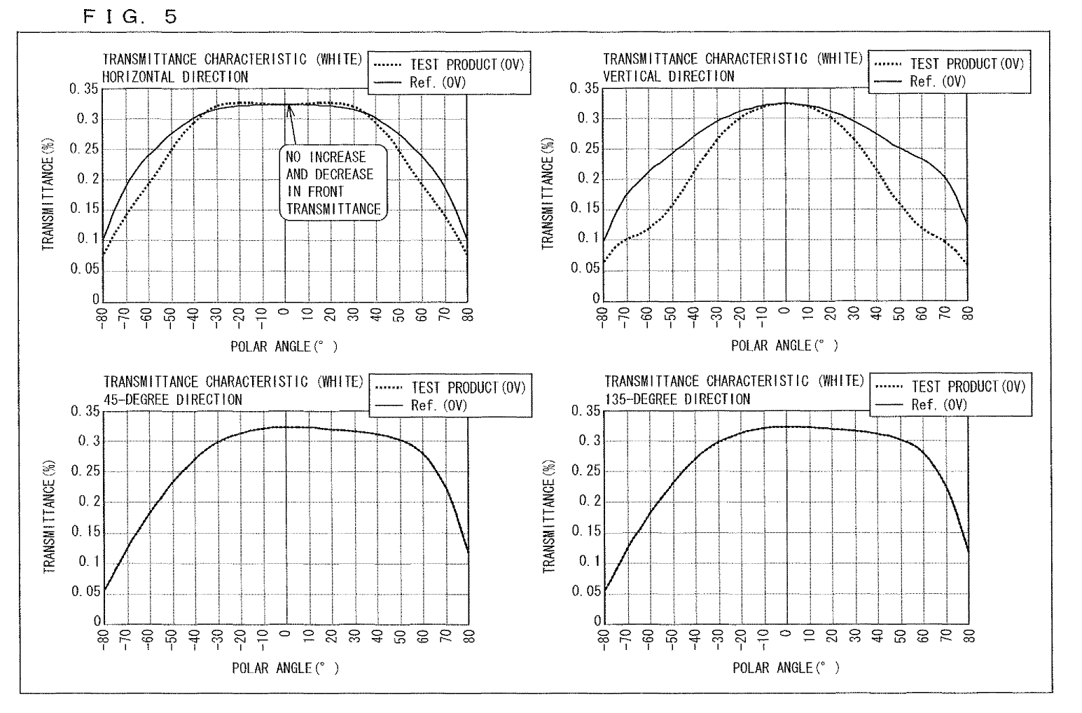

FIG. 5 illustrates respective transmittance characteristics of the “test product” and the “Ref.” which transmittance characteristics were measured as above in the four azimuths. Note that directions of the transmittance axes C1 and C2 of the respective polarizing plates were set to correspond to the azimuth directions at 45° and 135°, respectively.

As a result, first, in all the azimuth directions, there was no difference, between the “test product” and the “Ref.”, in a front transmittance obtained when the polar angle is 0°, that is, when the display surface is seen directly from the front. Then, when the polar angle was shifted, the “test product” had slightly lower transmittances than the “Ref.” in the azimuth directions at 0° (in the horizontal direction) and at 90° (in the vertical direction), and there was no difference in transmittance between the “test product” and the “Ref.” in the azimuth directions at 45° and 135°.

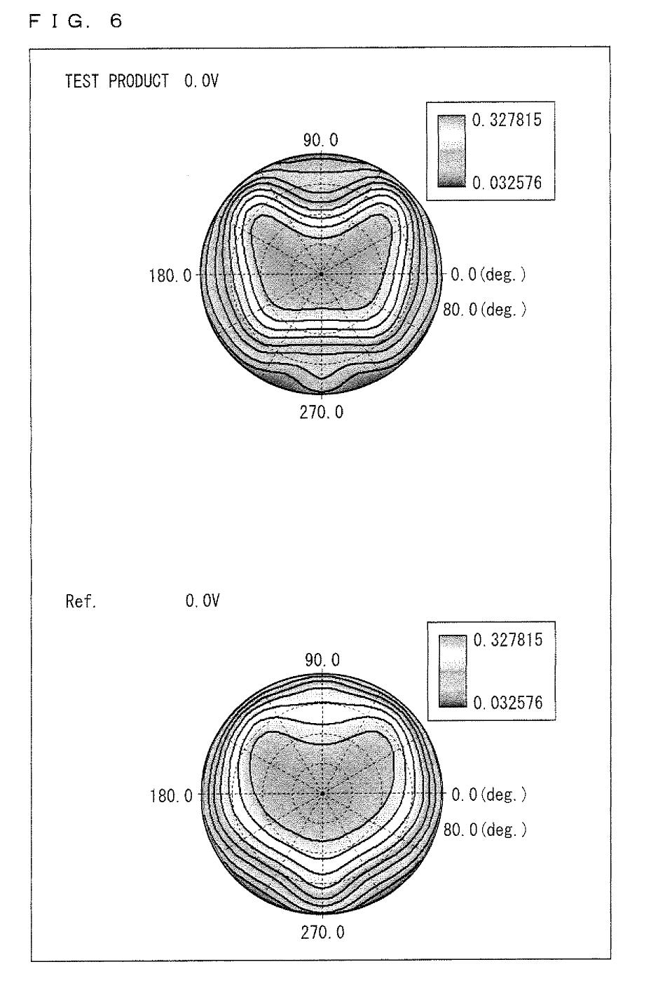

FIG. 6 illustrates a measurement result identical to that in FIG. 5 in a different notational method. FIG. 6 illustrates, by a contour chart, a distribution of the transmittances with respect to the azimuths and the polar angles. In the azimuth direction at 90° (in the vertical direction), as the polar angle increases, both the “test product” and the “Ref.” have respective lower transmittances than in the other azimuth directions. Therefore, this appears as dents of contours. The dents are slightly greater in the “test product” than in the “Ref.”.

(Transmittance Characteristic: Black Display)

Next, a transmittance characteristic of the “test product” was measured during a black display in which a voltage of 6.5 (V) was applied, whereas a transmittance characteristic of the “Ref.” was measured during the black display in which a voltage of 5.0 (V) was applied.

Note that a liquid crystal material and a value of a GRP film were set so that the “Ref.” had the largest viewing angle while the voltage of 5.0V is being applied. On the other hand, a liquid crystal material and a GRP film which were identical to those used for the “Ref.” were used for the “test product”. However, an applied voltage at which the “test product” had the largest viewing angle was set to 6.5V because another NAZ film was added. In case of trying to apply an identical voltage to each of the “test product” and the “Ref.”, it is necessary to change either the liquid crystal material or the GRP film.

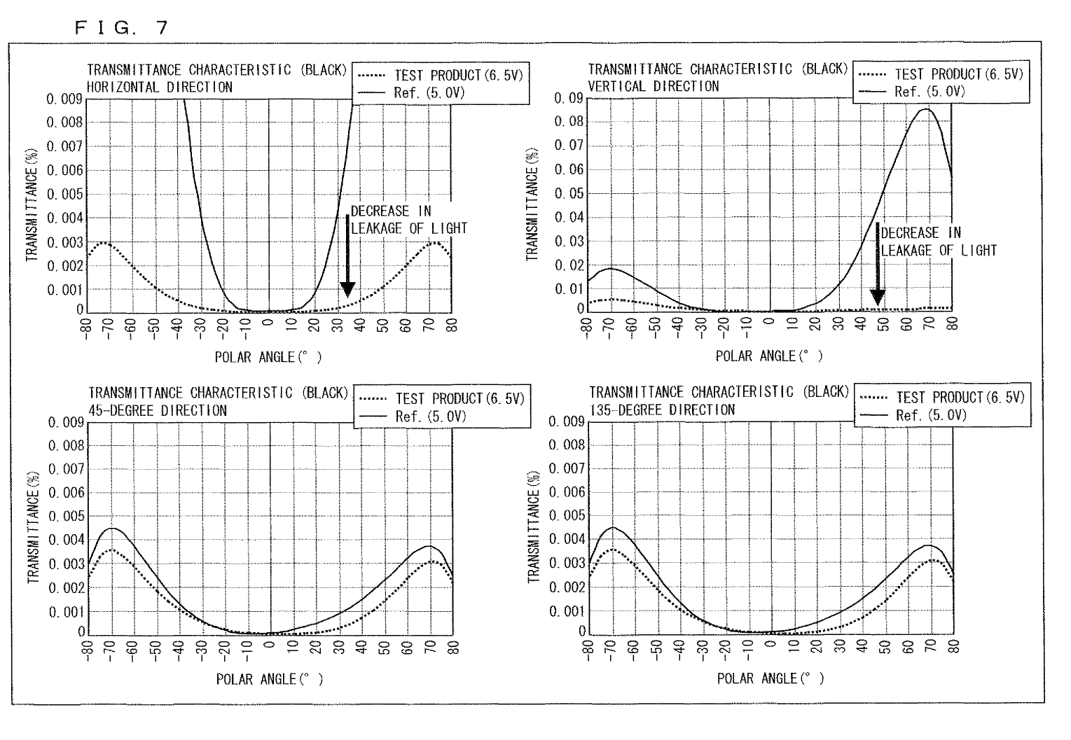

FIG. 7 illustrates a measurement result of transmittance characteristics obtained during the black display. As is clear from FIG. 7, in the “Ref.”, more light leaked and there occurred an upsurge in transmittance as the polar angle increased in the azimuth directions at 0° (in the horizontal direction) and at 90° (in the vertical direction), whereas in the “test product”, there was only a slight increase in leakage of light even if the polar angle increased. It is shown that an effect of a decrease in leakage of light is remarkable particularly in the azimuth direction at 90° (in the vertical direction).

Furthermore, the effect of a decrease in leakage of light was clearly shown also in the azimuth directions at 45° and 135°.

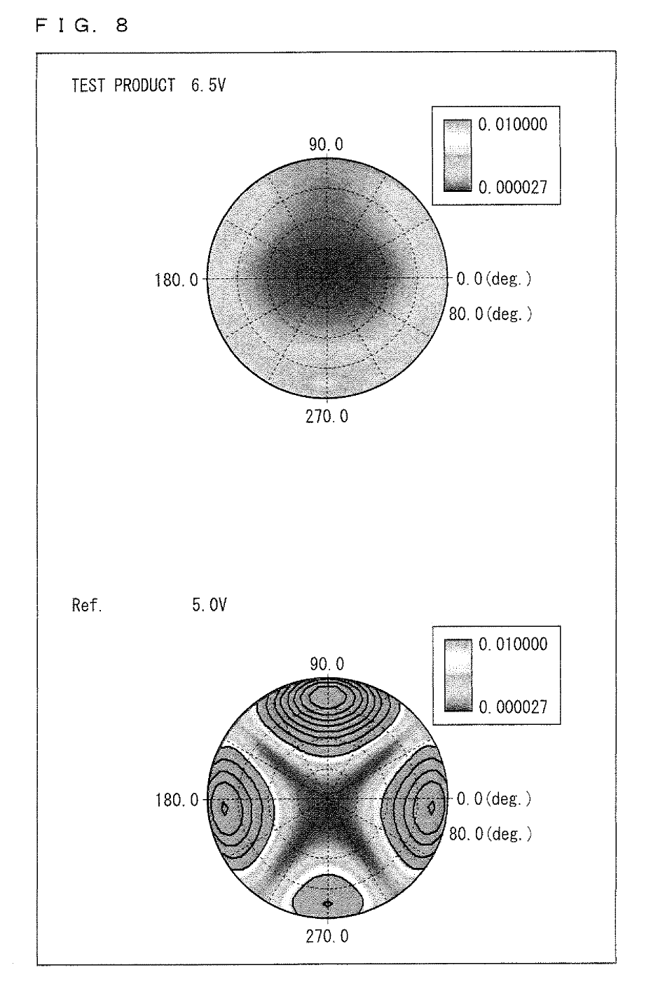

FIG. 8 illustrates, in a different notational method, a measurement result identical to that in FIG. 7 as a contour chart. As is clear from FIG. 8, in the “test product”, no contour which represents an increase in transmittance appears in all the azimuth directions and all the polar angles, whereas in the “Ref.”, a plurality of contours which represent a gradual increase in transmittance appear in the azimuth directions in the horizontal (right and left) direction and the vertical (upward and downward) direction.

(Contrast Characteristic)

In accordance with the above transmittance characteristics, it is possible to determine contrast characteristics of the liquid crystal display device of the present invention by use of the following equation.

Contrast=a transmittance obtained during the white display/a transmittance obtained during the black display

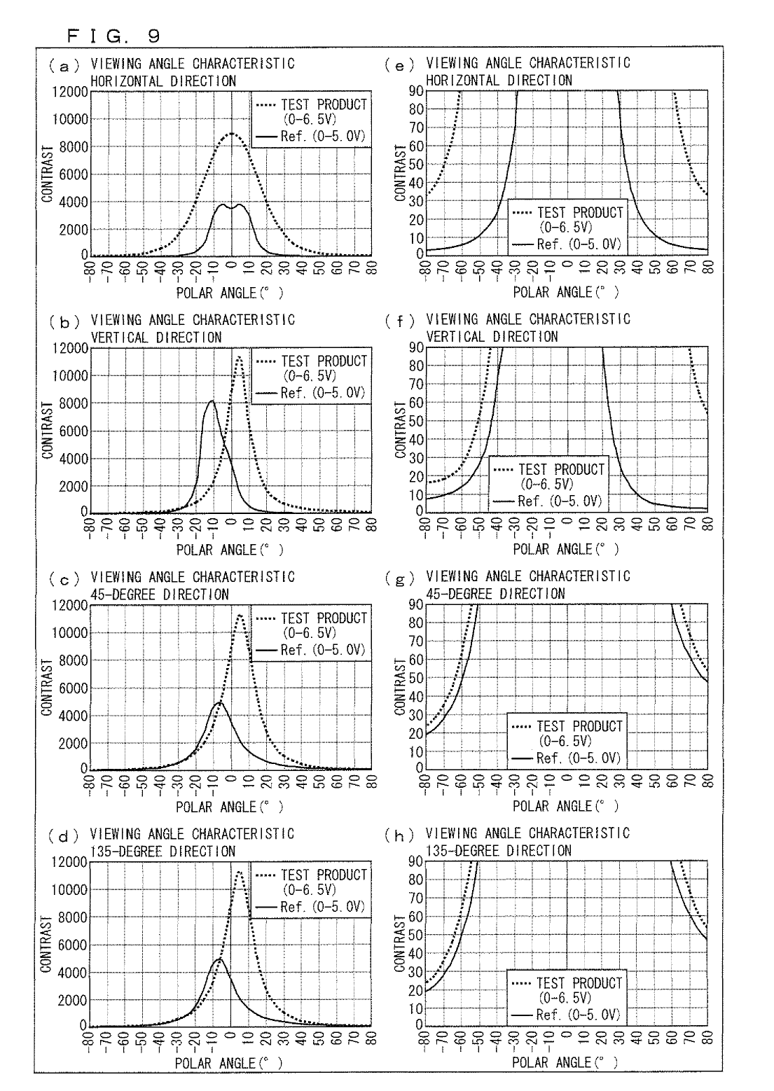

FIG. 9 illustrates respective contrast characteristics of the “test product” and the “Ref.” which contrast characteristics were determined with respect to the four azimuth directions which are identical to those in the case of the transmittance characteristics. In each of the graphs (a) through (d) of FIG. 9, a longitudinal axis and a transverse axis indicate a contrast and a polar angle, respectively. Note that a scale of the longitudinal axis is set so that peaks of respective contrasts of the “test product” and the “Ref.” are plotted. On the other hand, in each of the graphs (e) through (h) of FIG. 9, a contrast in the range of 0 to 90 in each of the above graphs (a) through (d) of FIG. 9 is extracted so as to find a change in value in a narrow range of the contrast.

As is clear from FIG. 9, in all the azimuth directions, the “test product” has much higher contrasts than the “Ref.”, and the “test product” has contrasts of more than 10 even at viewing angles where the polar angle approaches ±90° and thus there occurs a decrease in contrast.

In greater detail, first, the “test product” has much higher peaks of contrasts than the “Ref.” in all the azimuth directions. A peak of a contrast appears when the display surface is seen from the vicinity of a normal direction (a polar angle of 0°).

Secondly, there is a remarkable effect of an improvement in contrast in the azimuth direction at 0° (in the horizontal direction), and the “test product” has several times higher contrasts than the “Ref.” in all the polar angles (see (a) of FIG. 9).

Such a remarkable improvement in contrast is because of the following reason. As described earlier, the “test product” had slightly lower transmittances than the “Ref.” in the azimuth directions at 0° (in the horizontal direction) and at 90° (in the vertical direction) during the white display, whereas a leakage of light was extremely well prevented in the azimuth directions at 0° (in the horizontal direction) and at 90° (in the vertical direction) during the black display.

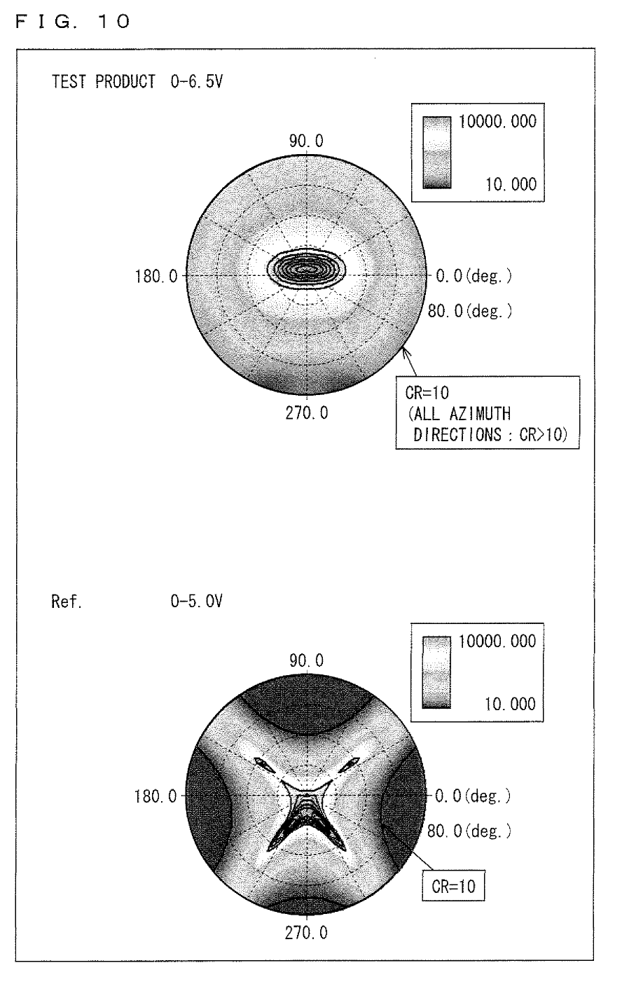

FIG. 10 illustrates, in a different notational method, a measurement result identical to that in FIG. 9 as a contour chart. As is clear from FIG. 10, in the “test product”, in all the azimuth directions and all the polar angles, no contour of a contrast of 10 (CR=10) appears, the “test product” has contrasts of more than 10, and a plurality of contours which represent a gradual increase in contrast appear like concentric circles. This shows that contrasts were uniformized irrespective of the azimuths.

In contrast, in the “Ref.”, the contour of the contrast of 10 appears in a plurality of azimuth directions having a certain degree of range in respective vicinities of the horizontal (right and left) direction and the vertical (upward and downward) direction. This causes bents to appear in regions where the “Ref.” has contrasts of more than 10. Such bents remain even in regions where the “Ref.” has a higher contrast. Namely, it is shown that in the plurality of azimuth directions where the “Ref.” has such low contrasts, the “Ref.” has a narrower range of viewing angles (polar angles) at which the “Ref.” shows high contrasts than the “test product”.

In the present example, the sloping direction A1 of the “retardation plate: GRP film” on the lower side of the liquid crystal display device, the sloping direction A2 of the “retardation plate: GRP film” on the upper side of the liquid crystal display device, the rubbing direction D1 of the lower substrate of the “liquid crystal layer”, and the rubbing direction D2 of the upper substrate of the “liquid crystal layer” were set as illustrated in FIG. 4. However, the present invention is not limited to this embodiment.

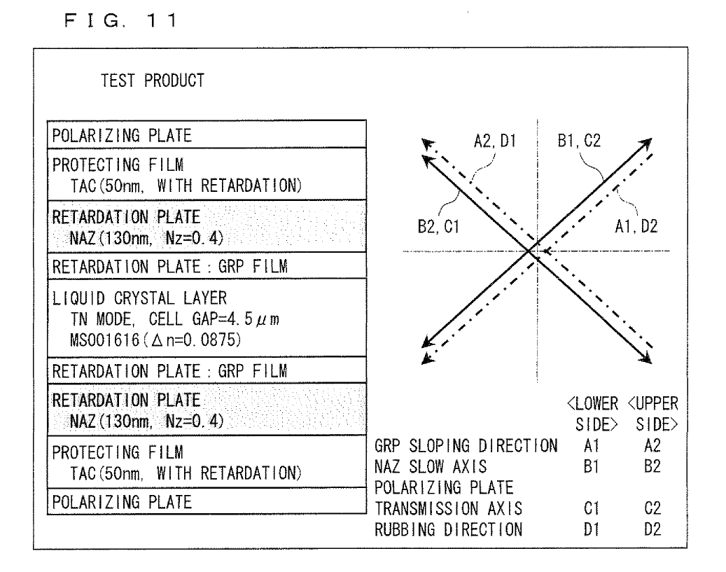

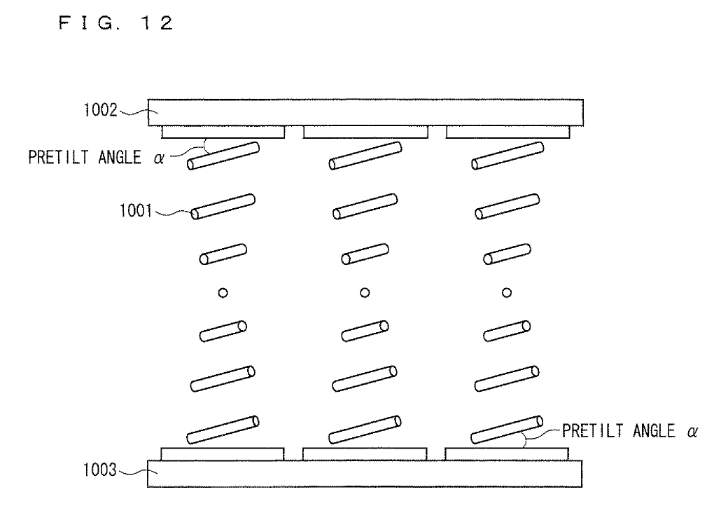

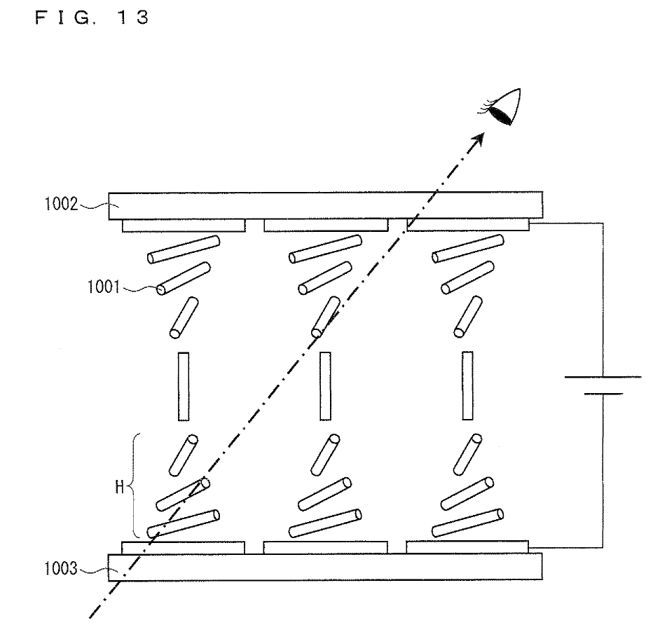

For example, instead of the arrangement such that an extending direction of the slow axis B1 of the second retardation film 3 are orthogonal to the sloping direction A1 and the rubbing direction D1 which are parallel to each other and identical in direction (see FIG. 4), the present invention may be arranged such that the sloping direction A1 and the rubbing direction D1 are orthogonal to each other and the rubbing direction D1 and the extending direction of the slow axis B1 are orthogonal to each other (see FIG. 11).

Further, instead of the arrangement such that: in a case where the rubbing direction D1 and the rubbing direction D2 are orthogonal to each other and the first composite retardation plate and the second composite retardation plate cause extending directions of the slow axis B1 and the slow axis B2 of the respective second retardation films 3 to be orthogonal to each other, the sloping direction A2 and the rubbing direction D2 are parallel to each other and identical in direction (see FIG. 4), the present invention may be arranged such that: the sloping direction A1 and the rubbing direction D2 are parallel to each other and the sloping direction A1 and the rubbing direction D2 which is opposite in direction to the rubbing direction D2 illustrated in FIG. 4 are identical in direction, and the sloping direction A2 and the rubbing direction D1 are parallel to each other and the sloping direction A2 and the rubbing direction D1 which is identical to the rubbing direction D1 illustrated in FIG. 4 are identical in direction (see FIG. 11).

Such arrangements also allow an increase in contrast of the “Ref.” which has low contrasts in the plurality of azimuth directions, and also allow the present invention to have a wider range of viewing angles (polar angles) at which the present invention shows high contrasts than the “Ref.”.

The present invention is not limited to the description of the embodiments above, but may be altered by a skilled person within the scope of the claims. An embodiment based on a proper combination of technical means disclosed in different embodiments is encompassed in the technical scope of the present invention.

As described earlier, a composite retardation plate in accordance with the present invention for use in a Twisted Nematic liquid crystal display device, at least includes: a first retardation film; and a second retardation film stacked on the first retardation film, the first retardation film being such that the first retardation film has a refractive index anisotropy which varies in thickness of the first retardation film so as to compensate for sequential variations in refractive index anisotropy of a liquid crystal layer included in the Twisted Nematic liquid crystal display device, the sequential variations being caused by a region which is approximately regarded as a region in which liquid crystal molecules hybridly orient during voltage application, and the second retardation film having a refractive index anisotropy for compensating for a residual refractive index anisotropy which remains after the compensation performed by the first retardation film.

Because of this, the light emitted from the composite retardation plate is one that is corrected so that the birefringence further approaches 0 (zero) than the conventional art, irrespective of a viewing angle. Therefore, in the TN liquid crystal display device with this composite retardation plate, the composite retardation plate enters not an elliptically polarized light but a substantially linearly polarized light into a polarizing plate of the composite retardation plate from which polarizing plate the light outgoes. This achieves an increase in contrast.

Furthermore, as described earlier, a Twisted Nematic liquid crystal display device in accordance with the present invention includes: a first composite retardation plate provided on a first substrate side; and a second composite retardation plate provided on a second substrate side, the first composite retardation plate and the second composite plate, each being provided in accordance with respective rubbing directions of the first substrate and the second substrate sandwiching the liquid crystal layer which respective rubbing directions are orthogonal to each other.

This brings about an effect that it is possible to provide a Twisted Nematic liquid crystal display device in which a viewing angle dependence of a contrast is greatly reduced and which is excellent in display quality.

The embodiments and concrete examples of implementation discussed in the aforementioned detailed explanation serve solely to illustrate the technical details of the present invention, which should not be narrowly interpreted within the limits of such embodiments and concrete examples, but rather may be applied in many changes within the spirit of the present invention, provided such changes do not exceed the scope of the patent claims set forth below.

### INDUSTRIAL APPLICABILITY

A composite retardation plate of the present invention and an optical compensation polarizing plate including the composite retardation plate are applicable to a Twisted Nematic liquid crystal display device for use in improving a viewing angle dependence of a contrast.

1. A composite retardation plate for use in a Twisted Nematic liquid crystal display device, at least comprising:
a first retardation film; and
a second retardation film stacked on the first retardation film,
the first retardation film being such that the first retardation film has a refractive index anisotropy which varies in thickness of the first retardation film so as to compensate for sequential variations in refractive index anisotropy of a liquid crystal layer included in the Twisted Nematic liquid crystal display device, the sequential variations being caused by a region which is approximately regarded as a region in which liquid crystal molecules hybridly orient during voltage application, and
the second retardation film having a refractive index anisotropy for compensating for a residual refractive index anisotropy which remains after the compensation performed by the first retardation film.

2. The composite retardation plate as set forth in claim 1, wherein:
the first retardation film has a refractive index anisotropy expressed by nx=ny>nz in the vicinity of a first surface and refractive index ellipsoids satisfying a relation of nx=ny>nz have slopes which vary in the thickness so that minor axes of the refractive index ellipsoids and the z-axis gradually form greater angles from the first surface toward a second surface; and
the second retardation film has a refractive index anisotropy expressed by nx>nz>ny,
where a z-axis is a thickness direction of the composite retardation plate and an x-axis and a y-axis are orthogonal to each other in a plane which is perpendicular to the thickness direction, and refractive indices of respective directions along the x-axis, the y-axis, and the z-axis are indicated as nx, ny, and nz, respectively, and
the first surface and second surface of the first retardation film are two surfaces of the first retardation film which face each other in the thickness direction and (i) the first surface faces the second retardation film and (ii) the second surface is a reverse side of the first surface.

3. The composite retardation plate as set forth in claim 2, wherein in the first retardation film, a sloping direction which has a direction in which the refractive index ellipsoids are sloped in such a manner that their minor axes are gradually tilted from the z-axis and which is parallel to the first surface is orthogonal to an extending direction of a slow axis of the second retardation film.

4. The composite retardation plate as set forth in claim 1, wherein at least one of the first retardation film and the second retardation film includes a protecting film which has a refractive index anisotropy for further compensating for a residual refractive index anisotropy which remains after the compensation performed by the first retardation film and the second retardation film.

5. An optical compensation polarizing plate comprising:
a composite retardation plate recited in claim 1, and
a polarizing plate for converting light which enters into the polarizing plate, into linearly polarized light.

6. A Twisted Nematic liquid crystal display device comprising an optical compensation polarizing plate recited in claim 5.

7. A Twisted Nematic liquid crystal display device comprising:
a first composite retardation plate as one of the composite retardation plate recited in claim 3; and
a Twisted Nematic liquid crystal layer sandwiched between a first substrate and a second substrate, the first substrate being stacked on a first retardation film included in the first composite retardation plate and the second substrate facing the first substrate,
in case of referring to (i) the sloping direction of the first retardation film included in the first composite retardation plate and (ii) a rubbing direction of the first substrate as a first sloping direction and a first rubbing direction, respectively, the first sloping direction and the first rubbing direction being parallel to each other and identical in direction.

8. The Twisted Nematic liquid crystal display device as set forth in claim 7 further comprising:
a second composite retardation plate as another one of the composite retardation plate recited in claim 3,
the second composite retardation plate including the first retardation film which is stacked on a surface of the second substrate which surface is opposite to a surface where the liquid crystal layer is provided,
in case of referring to (i) the sloping direction of the first retardation film included in the second composite retardation plate and (ii) a rubbing direction of the second substrate as a second sloping direction and a second rubbing direction, respectively, the second sloping direction and the second rubbing direction being parallel to each other and identical in direction,
the first rubbing direction and the second rubbing direction being orthogonal to each other.

9. The Twisted Nematic liquid crystal display device as set forth in claim 8, wherein in each of the first composite retardation plate and the second composite retardation plate, at least one of the first retardation film and the second retardation film includes a protecting film which has a refractive index anisotropy for compensating for a residual refractive index anisotropy which remains after the compensation performed by the first retardation film and the second retardation film.
